(19) United States
(12) Patent Application Publication
(10) Pub. No.: US 2022/0221347 A1
(43) Pub. Date: Jul. 14, 2022

(54) TEMPERATURE MEASURING DEVICE FOR A STATOR OF AN ELECTRICAL MACHINE WITH HAIRPIN OR ROD WAVE WINDINGS

(71) Applicant: Schaeffler Technologies AG & Co. KG, Herzogenaurach (DE)

(72) Inventors: Mike Czerlewitz, Bühl (DE); Christian Silvery, Walzbachtal (DE)

(73) Assignee: Schaeffler Technologies AG & Co. KG, Herzogenaurach (DE)

(21) Appl. No.: 17/610,474

(22) PCT Filed: Apr. 15, 2020
(86) PCT No.: PCT/DE2020/100299

§ 371 Date: Nov. 11, 2021

(30) Foreign Application Priority Data
May 14, 2019 (DE) 10 2019 112 516.2

(51) Int. Cl. G01K 1/14; H02K 11/25

(52) U.S. Cl. CPC G01K 1/146; H02K 11/25

(57) ABSTRACT

A temperature measuring device is disclosed for a stator of an electrical machine having hairpin or rod wave windings and for measuring the temperature of the stator. The temperature measuring device includes
a sensor device for measuring the temperature of the stator,
a holding device for holding the sensor device on a winding of the stator,
wherein the holding device is designed to engage behind at least one winding of the stator and to latch onto it.

### CROSS-REFERENCE TO RELATED APPLICATIONS

This application is the U.S. National Phase of PCT Appln. No. PCT/DE2020/100299 filed Apr. 15, 2020, which claims priority to DE 102019112516.2 filed May 14, 2019, the entire disclosures of which are incorporated by reference herein.

### TECHNICAL FIELD

The disclosure relates to a temperature measuring device for a stator of an electrical machine with hairpin or rod wave windings, which is used to measure the temperature of the stator. The disclosure also relates to an electrical machine with hairpin or rod wave windings.

### BACKGROUND

Various winding technologies for the stator of the electrical machines are known for the development of electrical machines, in particular electrical machines for electrical hybrid vehicles and for electrical vehicles or for wheel hub drives.

For example, an arrangement for temperature detection of a stator winding of an electrical machine according to DE10 2013 201 835 A1 is known from the prior art.

In this arrangement, a temperature sensor, which is arranged on a lance, can be inserted in a self-supported manner between two stator winding sections.

The temperature sensor is arranged in a housing of the electrical machine via a connection conductor alignment element and is also protected by an outer plastic sleeve.

Such a design is not suitable for a particularly dense or compact winding, such as the so-called hairpin or rod wave winding, since the gaps between individual winding sections are very small.

In other words, temperature detection is difficult with such windings (hairpin or rod wave windings) because they are very tightly wound or equipped so that a conventional temperature sensor cannot be inserted between the windings or the respective wires, or this may be done only very poorly and with great effort.

### SUMMARY

It is therefore the object of the present disclosure to provide a temperature measuring device for a stator of an electrical machine with hairpin or rod wave windings and for measuring the temperature of the stator, as well as an electrical machine with hairpin or rod wave windings, which is inexpensive and simple, and preferably provides a permanent and stable thermal connection of a temperature sensor to a hairpin or rod wave winding of a stator.

A further object of the present disclosure is to specify a temperature measuring device and an electrical machine which compensate manufacturing and material tolerances and movements due to vibrations and temperature changes.

According to the disclosure, these objects are achieved by the features of the independent claims. Further advantageous developments form the subject matter of the dependent claims.

According to the disclosure, in a first aspect of the present disclosure, a temperature measuring device for a stator of an electrical machine with hairpin or rod wave windings and for measuring the temperature of the stator comprises:

a sensor device for measuring the temperature of the stator, and

a holding device for holding the sensor device on a winding of the stator.

The holding device is preferably designed to engage behind at least one winding of the stator and to latch onto said winding.

In other words, it is preferred that the holding device is designed to press the sensor device on an outside of the hollow cylindrical stator against a winding or against the winding geometry or an insulation paper and on an inner side to latch it onto at least one winding of the hollow cylindrical stator, in particular in a detachable manner. In this way, an inexpensive, simple, and preferably permanent and above all detachable connection of a sensor device to a hairpin or rod wave winding of a stator can be provided. This also allows compensation of the manufacturing and material tolerances of a stator and its movements during operation of the electrical machine due to vibrations and temperature changes, since the sensor device is no longer arranged inside the stator, as in the prior art, but outside. A stable thermal connection of the sensor device to a hairpin or rod wave winding can thus also be provided.

The holding device advantageously has a receiving part for the sensor device and/or at least one latching part for latching onto at least one winding of the stator and/or at least one positioning part for positioning the temperature measuring device on a winding.

The receiving part is preferably formed and aligned in a first plane and the at least one latching part is formed and aligned in a second plane.

It can be provided that the first and second planes intersect, in particular are aligned perpendicularly to one another.

It is also advantageous if the holding device has a first and a second end in the axial direction.

The at least one positioning part is preferably arranged at the first end.

It is also advantageous if the at least one latching part is arranged, in particular spring-mounted, on the first end. In this way, a force can be generated with the aid of the spring-loaded design.

The at least one positioning part and the at least one latching part are advantageously spaced apart from one another in the circumferential direction.

The at least one latching part advantageously has a first and a second end in the radial direction, the at least one latching part preferably being connected with its first end to the receiving part of the holding device, in particular as a single piece. A single-piece design simplifies the manufacturing and assembly work and reduces costs.

It is also favorable that the at least one latching part extends away from the receiving part in a self-supported manner in the radial direction.

It is also advantageous if the at least one latching part at its second end has a latching part, in particular a hook, for engaging behind and latching onto a winding.

The at least one latching part advantageously has a spring element which is arranged between the first and second ends of the latching part so as to use a spring force to press the sensor device against a winding or an insulating paper.

It is also advantageous if the spring element has a sigma-shaped or E-shaped profile, in particular in the second plane. The spring element preferably has the task of generating a force in the second plane which generates a tensioning force so as to fix the temperature measuring device.

In addition, it can be provided that the holding device has comprises two latching parts, which are spaced apart from one another in the circumferential direction.

The at least one positioning part is preferably arranged at the first end of the holding device.

Furthermore, it is preferred that the at least one positioning part extends away in the radial direction from the receiving part of the holding device.

The at least one positioning part is advantageously designed in the shape of a cuboid.

It is also advantageous if the at least one positioning part is connected in a single piece to the receiving part.

It can also be provided that the holding device comprises two positioning parts which are spaced apart from one another in the circumferential direction.

It is also conceivable that the two positioning parts are spaced apart from one another in such a way that the sensor device can be arranged between them.

Furthermore, it is possible for the at least one positioning part and the at least one latching part to extend from the receiving part in the same direction, in particular in the same second plane.

The receiving part advantageously has a receiving section, in particular designed as a recess, for receiving the sensor device.

It is also advantageous if the receiving section extends from the first to the second end of the holding device.

It is also advantageous if the temperature measuring device comprises an alignment element which is arranged in the receiving section and aligns the sensor device on a winding of the stator.

In other words, it is preferred that the temperature measuring device comprises an alignment element which is arranged between the holding device and the sensor device so as to exert a force on the sensor device so that the sensor device can be pressed against a winding over a large area.

The alignment element preferably extends along the receiving section.

Furthermore, it can be provided that the alignment element is made from a plastic, in particular from a preferably soft, elastomer material. In this way, a stable thermal connection of the sensor device to a hairpin or rod wave winding can be provided. In other words, the alignment element is designed to be deformed in such a way that the sensor device is always pressed against a hairpin or rod wave winding of an electrical machine in the best possible way so as to ensure the largest possible area of the sensor device in contact with a wave winding.

The sensor device preferably comprises a temperature sensor.

It is also preferred that the sensor device comprises a cable connection for connecting a temperature sensor to an evaluation unit.

The cable connection is preferably at least partially connected to the holding device, in particular partially cast therein.

The sensor device advantageously has a first and a second end in the axial direction, the temperature sensor being preferably arranged at the first end and the cable connection being arranged at the second end.

Furthermore, it is advantageous if the sensor device comprises a protective device, in particular a PTFE sheathing, for example in the form of a shrink tube, which encloses the temperature sensor, in particular completely, and at least partially encloses the cable connection.

Furthermore, it is advantageous if the sensor device is adapted to a receiving section of the holding device in terms of shape and size. It is of course also possible for the receiving section to be adapted to the geometry of the sensor device.

Finally, it should also be noted that it can be provided that the temperature measuring device is made of a plastic.

A second aspect of the present disclosure comprises an electrical machine with hairpin or rod wave windings.

Reference is explicitly made to the fact that the features of the temperature measuring device, as mentioned under the first aspect, can be used individually or in combination with one another in the electrical machine.

In other words, the features mentioned above under the first aspect of the disclosure relating to the temperature measuring device can also be combined with further features under the second aspect of the disclosure.

An electrical machine with hairpin or rod wave windings preferably comprises:
a hollow cylindrical stator, in particular made with hairpin or rod wave windings, with at least one winding, and
a temperature measuring device according to the first aspect.

Furthermore, it is preferred that the temperature measuring device with its sensor device is arranged on a first winding and that two latching parts are latched onto a further winding so as to hold the temperature measuring device in position on the stator.

The latching parts preferably have a length such that they extend from the outer circumferential surface of the stator to its inner circumferential surface. In other words, it is advantageous if the latching parts extend through the wall thickness of the hollow cylindrical stator, whereas the temperature measuring device is located on the outside or on the outer jacket surface of the stator.

The inventive concept presented above will be further described in different words below.

This concept preferably consists—to put it simply—of mounting a temperature sensor or a sensor device by means of a clip or a holding device on a hairpin or rod wave winding of a stator.

By means of an alignment element, preferably made of an elastomer, the radial and tangential compensation of manufacturing and material tolerances as well as the compensation of movements due to vibrations and temperature changes is preferably carried out and a permanent and stable thermal connection is provided. Such a concept is characterized by particularly simple and safe production.

### BRIEF DESCRIPTION OF THE DRAWINGS

The disclosure will be explained in more detail below using an exemplary embodiment in conjunction with associated drawings. Shown schematically figures:

FIG. 1 shows a three-dimensional view of a temperature measuring device according to the disclosure for a stator of an electrical machine;

FIG. 2 shows a three-dimensional view of a sensor device from FIG. 1; and

FIG. 3 to FIG. 6 show different side views and different spatial views of a partial section of an electrical machine with a temperature measuring device according to the disclosure from FIG. 1.

### DETAILED DESCRIPTION

In the description below, the same reference signs will be used for the same components.

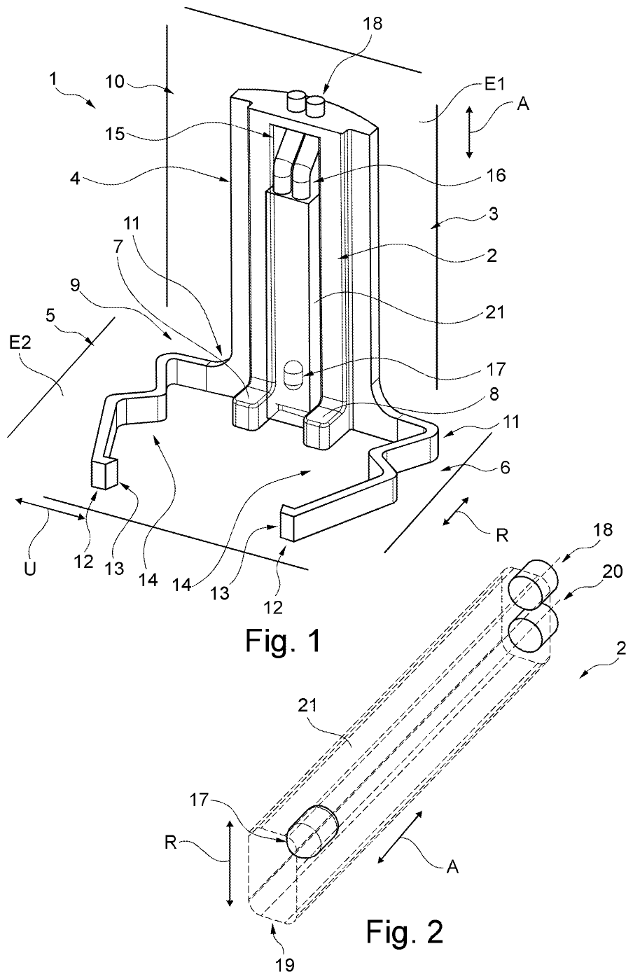

FIG. 1 shows a three-dimensional view of a temperature measuring device 1 according to the disclosure for a stator 31 of an electrical machine 30.

Illustrated in more detail, FIG. 1 shows a temperature measuring device 1 for a stator 31 of an electrical machine 30 with hairpin or rod wave windings 32, 33, 34 and for measuring the temperature of the stator 31.

The temperature measuring device 1 has a sensor device 2 for measuring the temperature of the stator 31 and a holding device 3 for holding the sensor device 2 on a winding 32 of the stator 31.

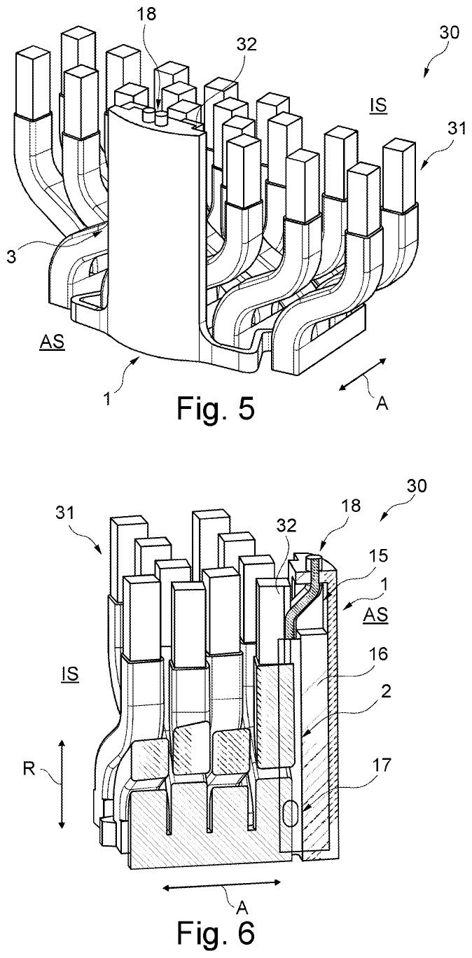

The holding device 3 is designed to engage behind two windings 33, 34 of the stator 31 and to latch onto them (cf., for example, FIGS. 3 to 6).

Furthermore, FIG. 1 shows that the holding device 3 has a receiving part 4 for the sensor device 2, two latching parts 5, 6 for latching onto a winding 32 of the stator 31 and two positioning parts 7, 8 for positioning the temperature measuring device 1 on a winding 32.

According to FIG. 1, the receiving part 4 is formed and aligned in a first plane E1 and the two latching parts 5, 6 are formed and aligned in a second plane E2, wherein the first and second planes E1, E2 are aligned perpendicularly to one another.

In the axial direction A, the holding device 3 has a first end 9 and a second end 10, wherein the two positioning parts 7, 8 and the two latching parts 5, 6 are arranged on the first end 9.

As can also be seen from FIG. 1, the two latching parts 5, 6 are spaced apart from one another in the circumferential direction U and each has a first end 11 and a second end 12 in the radial direction R, wherein each latching part 5, 6 is integrally connected by its first end 11 to the receiving part 4 of the holding device 3.

Each latching part also extends 5, 6 in a self-supported manner in the radial direction R from the receiving part 4, wherein each latching part 5, 6 at its second end 12 has a latching element 13, designed as a hook, for reaching behind and latching onto a winding 33, 34 or on an insulating paper of the electrical machine 30 (see also FIGS. 3 to 6).

A spring element 14 is arranged between the first end 11 and second end 12 of the latching part 5, 6 so as to press the sensor device 2 against a winding 32 with a spring force.

The spring element 14 has, in particular in the second plane E2, a sigma-shaped or E-shaped profile. This profile can look different depending on the design of the spring element 14.

It can also be seen from FIG. 1 that each positioning part 7, 8 is arranged at the first end 9 of the holding device 3, wherein each positioning part 7, 8 extends in the radial direction R away from the receiving part 4 of the holding device 3.

The positioning parts 7, 8 and the latching parts 5, 6 thus extend from the receiving part 4 in the same direction.

Furthermore, the positioning parts 7, 8 are cuboid and are connected in a single piece to the receiving part 4.

Furthermore, the two positioning parts 7, 8 of the holding device 3 are spaced apart from one another in the circumferential direction U, namely in such a way that the sensor device 2 is arranged between them.

As FIG. 1 also reveals, the receiving part 4 has a receiving section 15, in particular designed as a recess, for receiving the sensor device 2.

The receiving section 15 extends from the first end 9 to the second end 10 of the holding device 3.

It can also be seen in FIG. 1 or better in FIG. 6 that the temperature measuring device 1 comprises an alignment element 16 which is arranged in the receiving section 15 and can align the sensor device 2 on a winding 32 of the stator 31.

The temperature measuring device 1 thus has an alignment element 16 between the holding device 3 and the sensor device 2 so as to exert a force on the sensor device 2 so that it can be pressed against a winding 32 over a large area (compare, for example, FIGS. 3 to 6 in this context).

The alignment element 16 extends along the receiving section 15 and is made of an elastomer material.

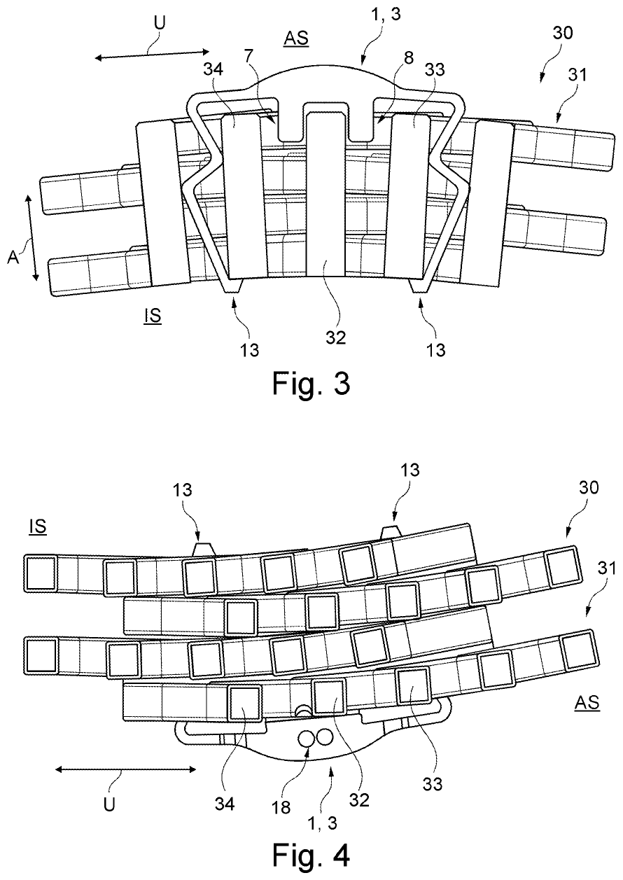

FIG. 2 shows a three-dimensional view of the sensor device 2 from FIG. 1.

Here, the sensor device 2 has a temperature sensor 17 and a cable connection 18 for connecting the temperature sensor 17 to an evaluation unit. This connection between temperature sensor 17 and cable connection 18 is preferably made by means of conventional connection technology, for example by welding or crimping the temperature sensor 17 and the required cable connection 18.

The temperature sensor 17 can be an NTC or PTC resistance element.

The cable connection 18 is partially connected to the holding device 3 or is partially cast in it (see FIG. 1, second end 10 of the holding device 3).

The sensor device 2 also has a first 19 end and a second end 20 in the axial direction A, wherein the temperature sensor 17 is arranged on the first end 19 and the cable connection 18 is arranged on the second end 20.

Furthermore, the sensor device 2 has a protective device 21, in particular a PTFE sheathing, for example in the form of a shrink tube, which completely and partially encloses the temperature sensor 17 and the cable connection 18.

So that the sensor device 2 can be arranged in the receiving section 15 of the holding device 3, it is adapted to the receiving section 15 in shape and size. It is of course also possible for the receiving section 15 to be adapted to the geometry of the sensor device 2.

Finally, it should be noted with regard to FIG. 1 that the temperature measuring device 1 is made of a plastic.

FIGS. 3 to 6 each shows different side views and different spatial views of a partial section of an electrical machine 30 with a temperature measuring device 1 according to the disclosure from FIG. 1.

Strictly speaking, FIGS. 3 to 6 show an electrical machine 30 with hairpin or rod wave windings.

The electrical machine 30 has a hollow cylindrical stator 31, produced with hairpin or rod wave windings 32, 33, 34, with several, in particular three windings 32, 33, 34.

Here, the temperature measuring device 1 from FIGS. 1 and 2 is arranged on the stator 31.

Further explanations relating to the temperature measuring device 1 are disregarded at this point and reference is made to the above explanations relating to FIGS. 1 and 2, which are analogously applicable here.

As already stated in relation to FIG. 1, the temperature measuring device 1 has a sensor device 2 for measuring the temperature of the stator 31 and a holding device 3 for holding the sensor device 2 on a winding 32 of the stator 31.

In other words, the holding device 3 is designed to press the sensor device 2 on an outer side AS of the hollow cylindrical stator 31 against a winding 32 and to detachably engage it on an inside IS on several windings 33, 34 of the hollow cylindrical stator 31.

As can be seen in particular from FIGS. 3 and 4, the temperature measuring device 1 with its sensor device 2 is arranged on a first winding 32, with two latching parts 5, 6 latched onto a further winding 33, 34 to keep the temperature measuring device 1 in position on the stator 31.

The latching parts 5, 6 have a length such that they extend from the outer lateral surface AS of the stator 31 to its inner lateral surface IS, whereby the latching elements 13 are latched onto the winding 33, 34.

The FIGS. 1 to 6 presented are described again below, but in other words.

Here, the basic idea of the inventive solution is preferably shown in FIG. 3.

There the sensor device 2 is held by a clip or by the holding device 3, which is latched onto a hairpin or rod wave winding and is guided by a soft element or the aligning element 16, e.g., an elastomer, presses evenly against the outer geometry of the winding 32.

The structure of the inventive solution is shown in FIG. 1, for example.

The connections or the cable connection 18 of the sensor device 3 is preferably connected to signal lines or cables by means of connection technology (for example welding, crimping, etc.).

The clip or the temperature measuring device 1 can be a plastic injection-molded part which is based on the geometry of the winding. This clip 1 also has an elastomer or an alignment element 16 in the receiving section 15 of the holding device 3, see FIG. 6, which has the task of compensating radial tolerances and pressing the temperature sensor 17 or the entire sensor device 2 against a winding.

This alignment element 16 is either positioned subsequently or is already produced with the holding device 3 from the outset.

The elastomer or the alignment element 16, which is located between the temperature measuring device 1 and the sensor device 2, improves the radial tolerance compensation in that the temperature sensor 17 or the sensor device 2 is pressed against the winding and against the alignment element 16.

The material of the alignment element 16 is preferably to be selected so that it can be compressed with little pressure and returns to the starting position when the temperature measuring device 1 is removed, so as to be repositioned later.

To mount the temperature measuring device 1 on the geometry of the hairpin or rod wave winding 32, additional webs or positioning parts 7, 8 are used for guidance and angular orientation.

When the end-mounted temperature measuring device 1 is pressed against the hairpin or rod wave winding 32, see FIGS. 3 to 6, an external force is exerted radially outwards.

The positioning parts 7, 8 now preferably have the task of guiding the temperature measuring device 1 through the hairpins until it is locked in its end position by the fixing hooks or locking elements 13.

Until this happens, the sensor device 3 presses against the soft elastomer or against the alignment element 16. Thus, in the end position of the temperature measuring device 1, an optimal connection of the temperature sensor 17 or sensor device 2 and hairpin or rod wave winding 32 is established.

### LIST OF REFERENCE NUMBERS

1 Temperature measuring device
2 Sensor device
3 Holding device
4 Receiving part
5 Latching part
6 Latching part
7 Positioning part
8 Positioning part
9 First end of the holding device
10 Second end of the holding device
11 First end of the latching part
12 Second end of the latching part
13 Latching element
14 Spring element
15 Receiving section
16 Alignment element
17 Temperature sensor
18 Cable connection
19 First end of the sensor device
20 Second end of the sensor device
21 Protective device
30 Electrical machine
31 Stator
32 Winding
33 Winding
34 Winding
A Axial direction
R Radial direction
U Circumferential direction
E1\ First plane
E2 Second plane
AS Outer side
IS Inner side

1. A temperature measuring device for a stator of an electrical machine having hairpin or rod wave windings and for measuring the temperature of the stator, comprising:
a sensor device for measuring the temperature of the stator,
a holding device for holding the sensor device on a winding of the stator,
wherein the holding device is configured to engage behind at least one winding of the stator and to latch onto it.

2. The temperature measuring device according to claim 1,
wherein the holding device is configured to press the sensor device on an outer side of the stator against a winding and to engage an inner side at least one winding of the stator.

3. The temperature measuring device according to claim 1,
wherein the holding device comprises at least one of:
a receiving part for the sensor device;
at least one latching part for latching onto at least one winding of the stator; and
one positioning part for positioning the temperature measuring device on a winding;
wherein the receiving part is formed and aligned in a first plane and the at least one latching part is formed and aligned in a second plane; and
wherein the first and second planes intersect.

4. The temperature measuring device according to claim 3,
wherein the holding device has a first end and a second end in an axial direction,
wherein the at least one latching part, is arranged on the first end, and
wherein the at least one positioning part is arranged on the first end.

5. The temperature measuring device according to claim 3,
wherein the at least one latching part has a first end and a second end in a radial direction,
wherein the at least one latching part is connected by its first end to the receiving part of the holding device,
wherein the at least one latching part extends in a self-supported manner in the radial direction from the receiving part,
wherein the at least one latching part has a latching element on its second end for reaching behind and latching onto a winding, and
wherein the at least one latching part has a spring element which is arranged between the first end and second end of the latching part, so as to use a spring force to press the sensor device against a winding.

6. The temperature measuring device according to claim 3,
wherein the at least one positioning part is arranged at the first end of the holding device,
wherein the at least one positioning part extends in a radial direction from the receiving part of the holding device,
wherein the at least one positioning part is cuboid, and
wherein the at least one positioning part is connected in a single piece to the receiving part.

7. The temperature measuring device according to claim 4,
wherein the receiving part has a receiving section for receiving the sensor device,
wherein the receiving section extends from the first end to the second end of the holding device,
wherein the temperature measuring device comprises an alignment element which is arranged in the receiving section and aligns the sensor device on a winding of the stator, and
wherein the alignment element is made from a plastic.

8. The temperature measuring device according to claim 1,
wherein the sensor device comprises a temperature sensor,
wherein the sensor device comprises a cable connection for connecting the temperature sensor to an evaluation unit,
wherein the cable connection is at least partially connected to the holding device, and
wherein the sensor device comprises a protective device, which encloses the temperature sensor and at least partially encloses the cable connection.

9. An electrical machine having hairpin or rod wave windings comprising:
a hollow cylindrical stator having at least one winding,
a temperature measuring device according to claim 1.

10. The electrical machine according to claim 9,
wherein the temperature measuring device with its sensor device is arranged on a first winding and two latching parts are each engaged on a further winding so as to keep the temperature measuring device in position on the stator,
wherein the latching parts have a length such that they extend from an outer jacket surface of the stator to its inner jacket surface.

11. The temperature measuring device according to claim 2, wherein the holding device is configured to engage the inner side in a detachable manner.

12. The temperature measuring device according to claim 3, wherein the first and second planes are aligned perpendicularly to one another.

13. The temperature measuring device according to claim 4, wherein the at least one latching part is spring-mounted on the first end.
